(19) United States
(12) Patent Application Publication
(10) Pub. No.: US 2012/0141278 A1
(43) Pub. Date: Jun. 7, 2012

(54) ROTOR BLADE ASSEMBLY AND METHOD FOR MODIFYING LOAD CHARACTERISTIC OF ROTOR BLADE IN WIND TURBINE

(75) Inventors: Christian A. Carroll, Simpsonville, SC (US); Jonathan Glenn Luedke, Simpsonville, SC (US); David Samuel Pesetsky, Greenville, SC (US)

(73) Assignee: GENERAL ELECTRIC COMPANY, Schenectady, NY (US)

(21) Appl. No.: 13/225,793

(22) Filed: Sep. 6, 2011

(51) Int. Cl. F03D 7/02; F03D 1/06

(52) U.S. Cl. 416/147

(57) ABSTRACT

A rotor blade assembly for a wind turbine and a method for modifying a load characteristic of a rotor blade in a wind turbine are disclosed. The rotor blade assembly includes a rotor blade having surfaces defining a pressure side, a suction side, a leading edge, and a trailing edge extending between a tip and a root. The rotor blade further defines a span and a chord. The rotor blade includes a body defining at least a portion of the pressure side, the suction side, and the trailing edge, and a nose feature movable with respect to the body. The rotor blade assembly further includes a controller operable to move the nose feature.

### FIELD OF THE INVENTION

The present disclosure relates in general to wind turbine rotor blades, and more particularly to rotor blade assemblies having movable nose features and methods for modifying the load characteristics of rotor blades in wind turbines.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known airfoil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

The size of the rotor blades of a wind turbine are frequently limited by the loading requirements for such rotor blades. For example, larger rotor blades may provide increases in power production, but may additionally results in increases in loading potential. Excess loading, such as during periods of high wind speeds or due to other various factors, may potentially damage a rotor blade and/or destroy a wind turbine. Thus, the design of these rotor blades is limited by the loading potential of the rotor blades, resulting in lower power production.

Various attempts have been made to allow for adjustment of the loading potential of a rotor blade during operation based on the loading environment for the wind turbine. For example, attempts have been made to allow for decreasing of the loading potential during periods of relatively higher loading. Such attempts have included the use of spoilers and/or trailing edge flaps on the rotor blades, which may be deployable during such higher loading periods. However, more effective methods and apparatus for decreasing such loading potential are desired in the art.

Accordingly, an improved rotor blade assembly and method for modifying a load characteristic of a wind turbine may be advantageous. For example, a rotor blade assembly that allows for adjustment of the loading potential of a rotor blade as desired during operation of a wind turbine would be advantageous.

### BRIEF DESCRIPTION OF THE INVENTION

Aspects and advantages of the invention will be set forth in part in the following description, or may be obvious from the description, or may be learned through practice of the invention.

In one embodiment, a rotor blade assembly for a wind turbine is disclosed. The rotor blade assembly includes a rotor blade having surfaces defining a pressure side, a suction side, a leading edge, and a trailing edge extending between a tip and a root. The rotor blade further defines a span and a chord. The rotor blade includes a body defining at least a portion of the pressure side, the suction side, and the trailing edge, and a nose feature movable with respect to the body. The rotor blade assembly further includes a controller operable to move the nose feature.

In another embodiment, a method for modifying a load characteristic of a rotor blade in a wind turbine is disclosed. The method includes measuring the load characteristic of the rotor blade, and moving a nose feature of the rotor blade with respect to a body of the rotor blade. The body defines at least a portion of a pressure side, a suction side, and a trailing edge of the rotor blade.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a wind turbine according to one embodiment of the present disclosure;

FIG. 2 is a top view of a rotor blade assembly according to one embodiment of the present disclosure;

FIG. 3 is a cross-sectional view of a rotor blade assembly according to one embodiment of the present disclosure in a closed position;

FIG. 4 is a cross-sectional view of a rotor blade assembly according to one embodiment of the present disclosure in an open position;

FIG. 5 is a cross-sectional view of a rotor blade assembly according to another embodiment of the present disclosure in a closed position;

FIG. 6 is a cross-sectional view of a rotor blade assembly according to another embodiment of the present disclosure in an open position;

FIG. 7 is a cross-sectional view of a rotor blade assembly according to another embodiment of the present disclosure in an open position;

FIG. 8 is a cross-sectional view of a rotor blade assembly according to another embodiment of the present disclosure in a closed position;

FIG. 9 is a cross-sectional view of a rotor blade assembly according to another embodiment of the present disclosure in an open position;

FIG. 10 is a cross-sectional view of a rotor blade assembly according to another embodiment of the present disclosure in a closed position; and,

FIG. 11 is a cross-sectional view of a rotor blade assembly according to another embodiment of the present disclosure in an open position.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

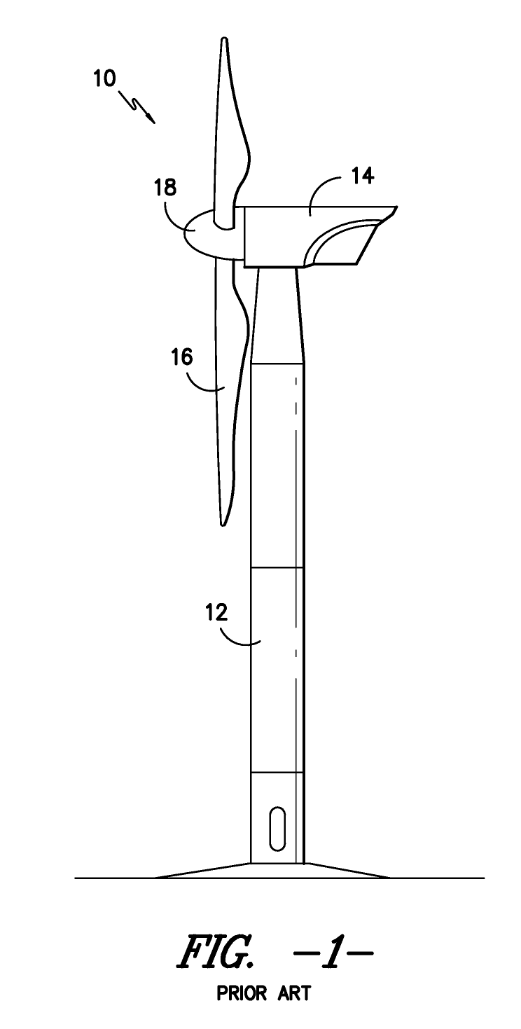

FIG. 1 illustrates a wind turbine 10 of conventional construction. The wind turbine 10 includes a tower 12 with a nacelle 14 mounted thereon. A plurality of rotor blades 16 are mounted to a rotor hub 18, which is in turn connected to a main flange that turns a main rotor shaft. The wind turbine power generation and control components are housed within the nacelle 14. The view of FIG. 1 is provided for illustrative purposes only to place the present invention in an exemplary field of use. It should be appreciated that the invention is not limited to any particular type of wind turbine configuration.

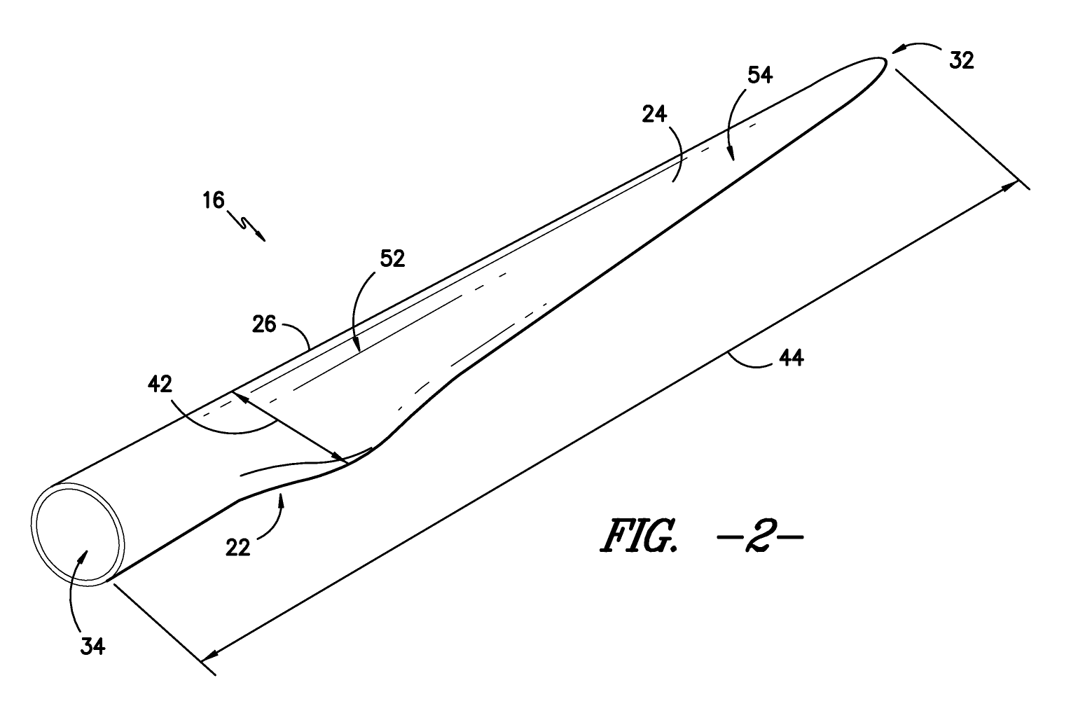

Referring to FIG. 2, a rotor blade 16 according to the present disclosure may include exterior surfaces defining a pressure side 22 and a suction side 24 (see FIGS. 3 through 5 and 7) extending between a leading edge 26 and a trailing edge 28, and may extend from a blade tip 32 to a blade root 34. The exterior surfaces may be generally aerodynamic surfaces having generally aerodynamic contours, as is generally known in the art.

In some embodiments, the rotor blade 16 may include a plurality of individual blade segments aligned in an end-to-end order from the blade tip 32 to the blade root 34. Each of the individual blade segments may be uniquely configured so that the plurality of blade segments define a complete rotor blade 16 having a designed aerodynamic profile, length, and other desired characteristics. For example, each of the blade segments may have an aerodynamic profile that corresponds to the aerodynamic profile of adjacent blade segments. Thus, the aerodynamic profiles of the blade segments may form a continuous aerodynamic profile of the rotor blade 16. Alternatively, the rotor blade 16 may be formed as a singular, unitary blade having the designed aerodynamic profile, length, and other desired characteristics.

The rotor blade 16 may, in exemplary embodiments, be curved. Curving of the rotor blade 16 may entail bending the rotor blade 16 in a generally flapwise direction and/or in a generally edgewise direction. The flapwise direction may generally be construed as the direction (or the opposite direction) in which the aerodynamic lift acts on the rotor blade 16. The edgewise direction is generally perpendicular to the flapwise direction. Flapwise curvature of the rotor blade 16 is also known as pre-bend, while edgewise curvature is also known as sweep. Thus, a curved rotor blade 16 may be pre-bent and/or swept. Curving may enable the rotor blade 16 to better withstand flapwise and edgewise loads during operation of the wind turbine 10, and may further provide clearance for the rotor blade 16 from the tower 12 during operation of the wind turbine 10.

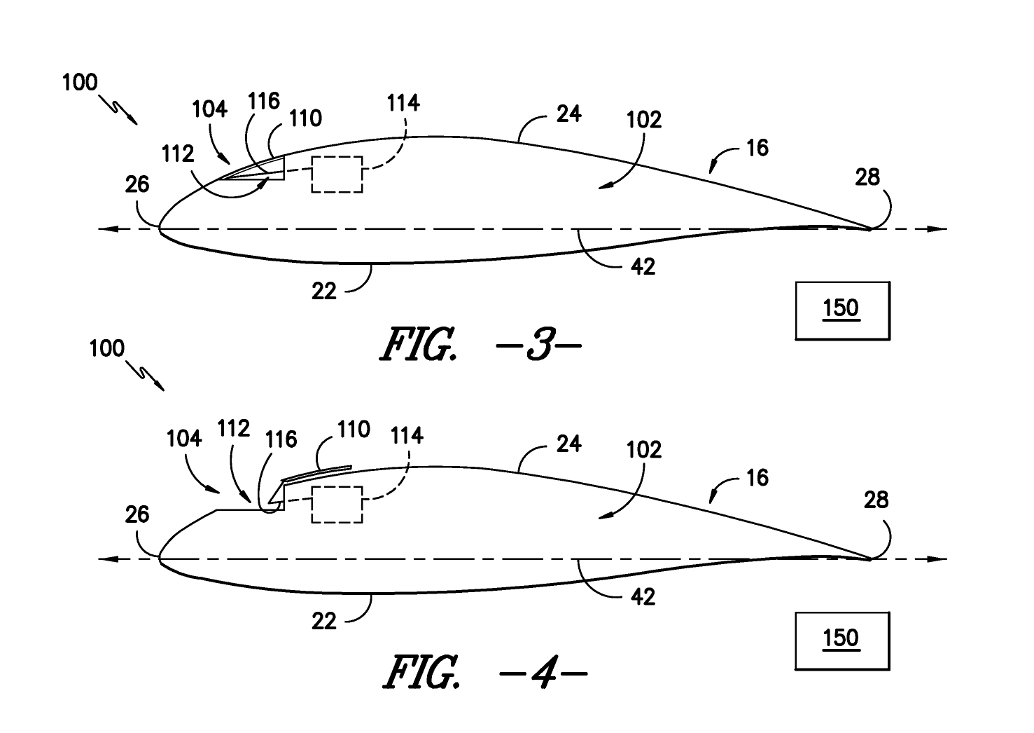

The rotor blade 16 may further define chord 42 and a span 44. As shown in FIGS. 2 and 4, the chord 42 may vary throughout the span 44 of the rotor blade 16. Thus, a local chord may be defined for the rotor blade 16 at any point on the rotor blade 16 along the span 44.

Additionally, the rotor blade 16 may define an in-board area 52 and an out-board area 54. The in-board area 52 may be a span-wise portion of the rotor blade 16 extending from the root 34. For example, the in-board area 52 may, in some embodiments, include approximately 33%, 40%, 50%, 60%, 67%, or any percentage or range of percentages therebetween, or any other suitable percentage or range of percentages, of the span 44 from the root 34. The out-board area 54 may be a span-wise portion of the rotor blade 16 extending from the tip 32, and may in some embodiments include the remaining portion of the rotor blade 16 between the in-board area 52 and the tip 32. Additionally or alternatively, the out-board area 54 may, in some embodiments, include approximately 33%, 40%, 50%, 60%, 67%, or any percentage or range of percentages therebetween, or any other suitable percentage or range of percentages, of the span 44 from the tip 32.

As illustrated in FIGS. 3 through 11, the present disclosure may further be directed to a rotor blade assembly 100. A rotor blade assembly 100 according to the present disclosure includes a body 102 and one or more nose features 104. The body 102 defines at least a portion of the pressure side 22, the suction side 24, and the trailing edge 28. The body 102 may further, in some embodiments, define at least a portion of the leading edge 26. A nose feature 104 may be movable with respect to the body 102. A nose feature 104 may include the nose or any portion thereof of a rotor blade 16, or may include a suitable device or component included in the nose, such as in the leading edge 26 or in the pressure side 22 or suction side 24 adjacent the leading edge 26, as discussed below. Movement of the nose feature 104 may modify one or more load characteristic of the rotor blade 16. Load characteristics may include, for example, lift, thrust, torque, drag, or any other suitable loading component that the rotor blade 16 may be subjected to during operation of the wind turbine 10. Modification of the load characteristics may include increasing or decreasing such load characteristics, thereby increasing or decreasing the loading and loading potential of the rotor blade 16. Further, as discussed below, a nose feature 104 may be moveable as desired or required during operation of the wind turbine 10 based on the current loading conditions for the rotor blade 16. This may allow the loading potential of the rotor blade 16 to be modified as required during periods of relatively higher or lower loading, and may further advantageously allow for reversion to standard loading potential for the rotor blade 16 during periods of normal loading.

In some embodiments, as shown in FIGS. 3 and 4, a nose feature 104 may include a panel 110 and a trip zone 112. In these embodiments, the body 102 may include at least a portion of the pressure side 22, suction side 24, leading edge 26, and trailing edge 28. The trip zone 112 may be a channel, depression, or other suitable indention defined in the pressure side 22 or the suction side 24 generally adjacent to the leading edge 26. When the trip zone 112 is exposed to, for example, a wind flow over the rotor blade 16, the trip zone 112 may disrupt such flow over the surface on which the trip zone 112 is defined. This disruption may modify a load characteristic of the wind turbine 10, such as lower a load characteristic, thus decreasing the loading and loading potential of the rotor blade 16.

The panel 110 may define a portion of the pressure side 22 and the suction side 24 adjacent to the leading edge 26. In particular, the panel 110 may be sized and shaped to cover the trip zone 112, as shown. Further, the panel 110 may be movable to reveal the trip zone 112. For example, FIG. 3 shows the panel 110 in a closed position generally covering the trip zone 112, while FIG. 4 shows the panel 112 in an open position generally revealing the trip zone 112. In some embodiments, as shown, the panel 110 may be generally translatable to reveal the trip zone 112, such as by sliding relative to the pressure side 22 or suction side 24. Such sliding may occur external to the pressure side 22 or suction side 24, as shown, or internal to such surfaces. Additionally or alternatively, the panel 110 may rotate to reveal the trip zone 112 as desired or required. Translation or rotation of the panel 110 may be in or about a chord-wise axis, a span-wise axis, an axis generally perpendicular to the chord-wise axis and span-wise axis, or in any other suitable direction. It should be understood that the panel 110 may be movable between a fully closed position and a fully open position, and may further be moved to any position therebetween as desired or required, thus allowing for incremental modifications in load characteristics.

An actuating device 114 may be included for moving the panel 110 relative to the trip zone 112 and relative to the pressure side 22 and/or suction side 24. The actuating device 114 may include any suitable actuatable components, such as hydraulic actuators, pneumatic actuators, electric actuators, gearboxes, drivetrains, screws, wheel and axle mechanisms. The actuating device 114 may be connected to the panel 110 for moving the panel 110 as desired or required. In some embodiments, the actuating device 114 may include, for example, an arm 116 connected between a suitable actuatable component and the panel 110 for moving the panel 110 in response to actuation of the actuatable component. The actuating device 114 may thus move the panel 110 between the closed and open positions, and to any position therebetween.

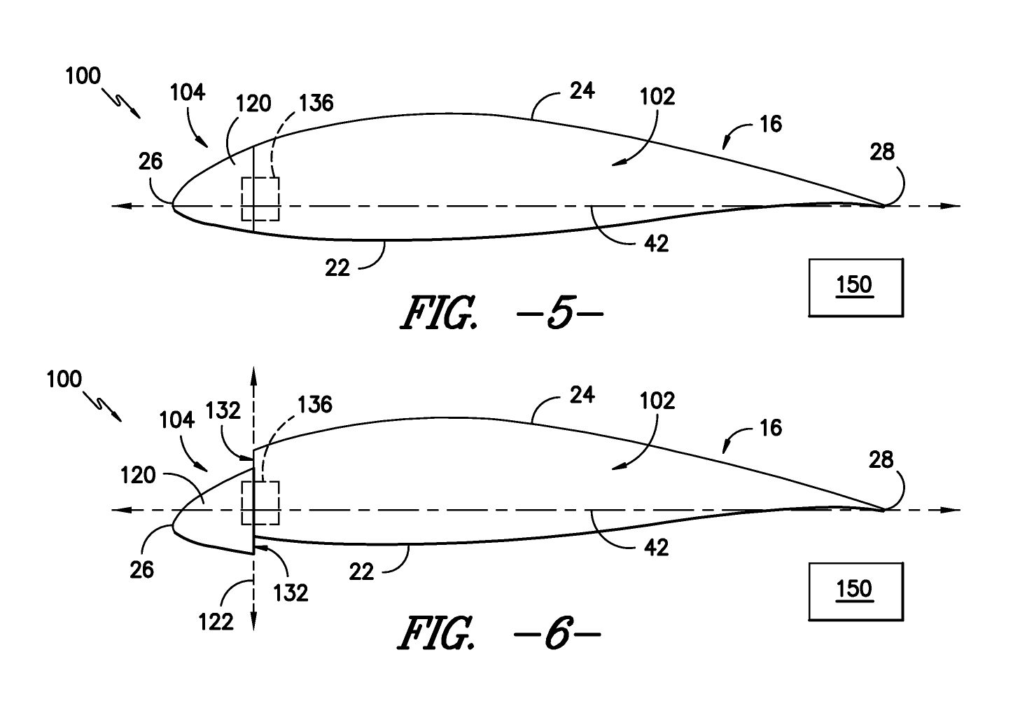

In other embodiments, as shown in FIGS. 5 through 11, the nose feature 104 may include a nose 120. The nose 120 may be a forward portion of the rotor blade 16 in the generally chord-wise direction, and may thus define at least a portion of the leading edge 26. Further, the nose 120 may define a portion of the pressure side 22 and/or suction side 24, as shown. The nose 120 may be movable with respect to the body 102. For example, as discussed below, in some embodiments the nose 120 may be translatable with respect to the body 102, while in other embodiments, the nose 120 may be additionally or alternatively rotatable with respect to the body 102.

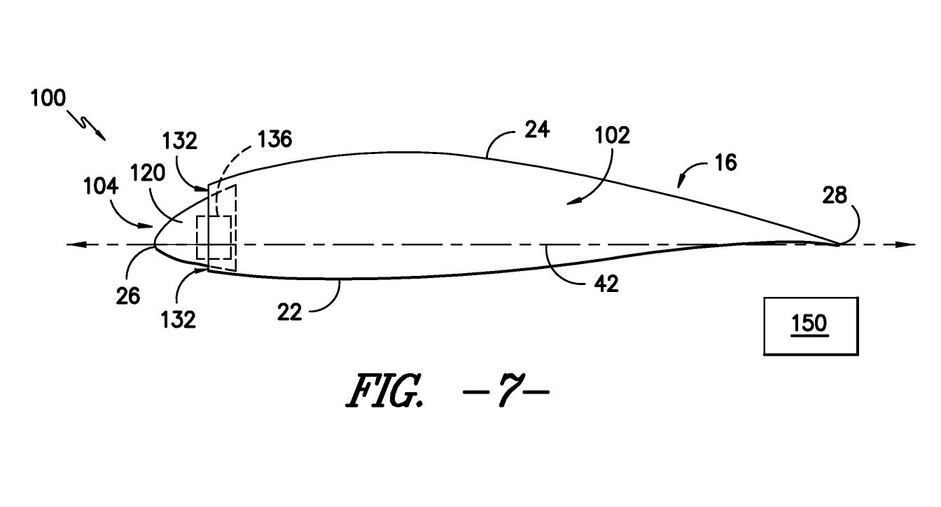

FIGS. 5 through 7 illustrate a nose 120 according to various embodiments of the present disclosure. FIG. 5 shows the nose 120 in a generally closed position, while FIGS. 6 and 7 show the nose 120 in alternative generally open positions. In these embodiments, the nose 120 is generally translatable with respect to the body 102. For example, in some embodiments as shown in FIG. 7, the nose 120 may be translatable in a generally chord-wise direction. Thus, the nose 120 may translate into and/or out of the body 102 in the generally chord-wise direction. In other embodiments, the nose 120 may be translatable in a generally span-wise direction. In other embodiments as shown in FIG. 6, the nose 120 may be translatable in a direction 122 generally perpendicular to the span 44 and the chord 42.

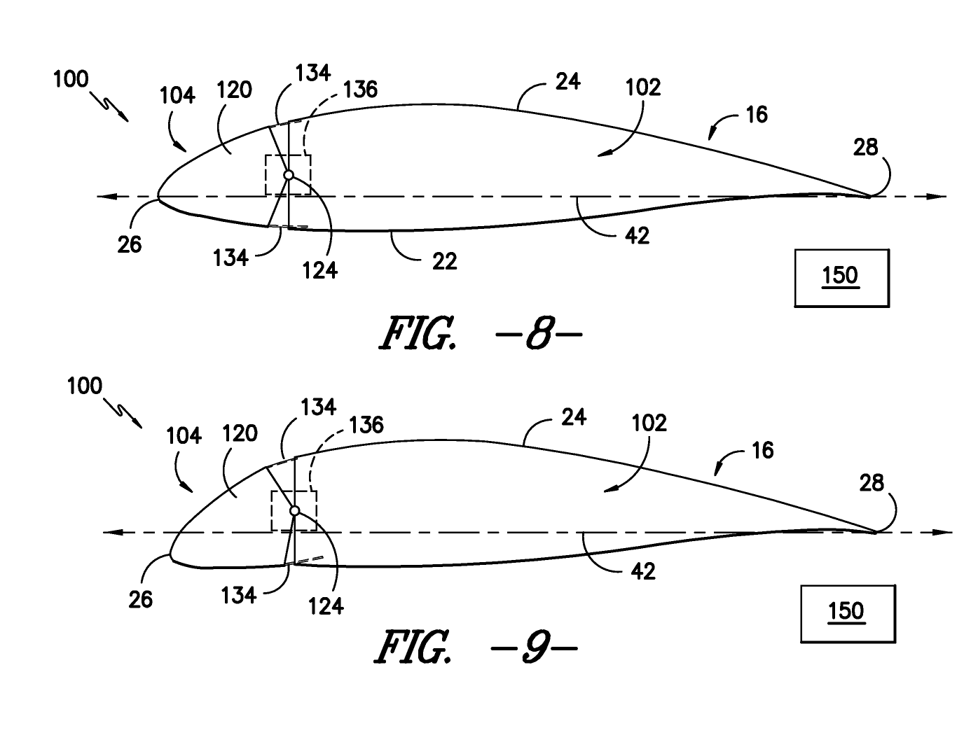

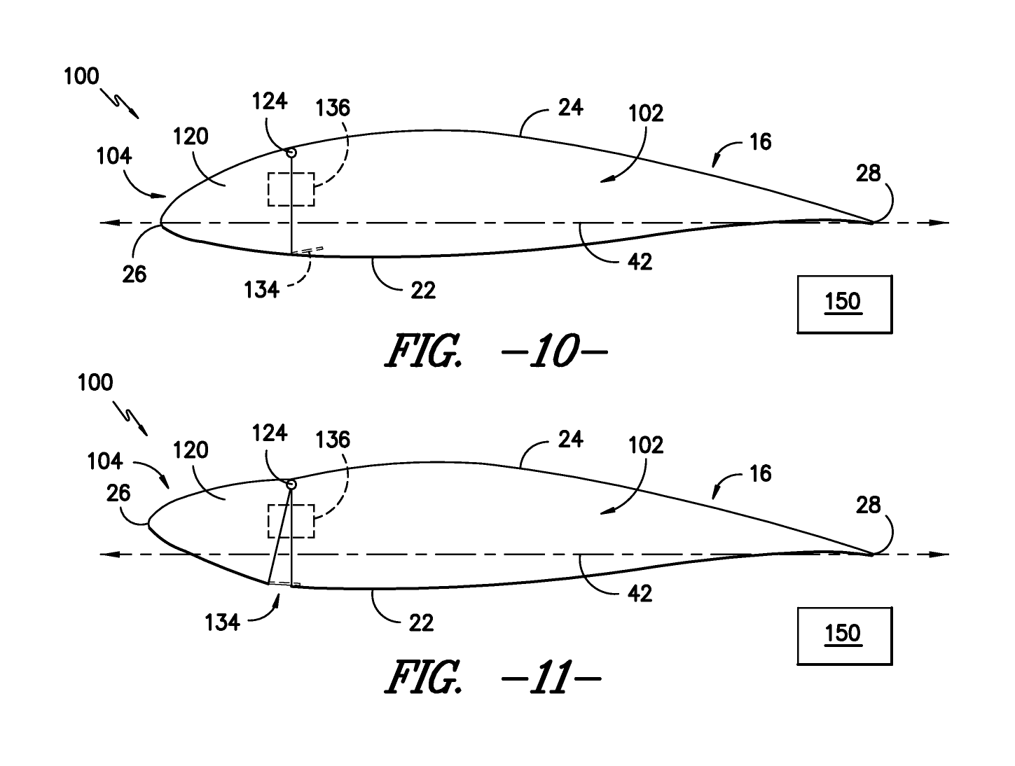

FIGS. 8 through 11 illustrate a nose 120 according to various other embodiments of the present disclosure. FIGS. 8 and 10 show the nose 120 in generally closed positions, while FIGS. 9 and 11 show the nose 120 in generally open positions. In these embodiments, the nose 120 is generally rotatable with respect to the body 102. For example, in some embodiments as shown, the nose 120 may be rotatable about a generally span-wise axis 124. The axis 124 may be located between the pressure side 22 and the suction side 24, as shown in FIGS. 8 and 9, or may be located on the pressure side 22 or the suction side 24 as shown in FIGS. 10 and 11. In other embodiments, the nose 120 may be rotatable about a generally chord-wise axis or about an axis that is generally perpendicular to the span 44 and chord 42.

Movement of the nose 120 as described above may, in some embodiments as shown in FIGS. 6 and 7, create and expose one or more trip zones 132. When a trip zone 132 is exposed to, for example, a wind flow over the rotor blade 16, the trip zone 132 may disrupt such flow over the surface on which the trip zone 132 is defined. This disruption may modify a load characteristic of the wind turbine 10, such as lower a load characteristic, thus decreasing the loading and loading potential of the rotor blade 16.

In other embodiments, as shown in FIGS. 8 through 11, a membrane 134 may be positioned between the nose 120 and the body 102 on the pressure side 26 and/or the suction side 28. A membrane 134 may cover a potential trip zone due to movement of the nose 120. A membrane 134 may be attached to the nose 120, thus moving with the nose 120 and covering potential trip zones, or may be attached to the body 102. In these embodiments, when the moved nose 120 is exposed to, for example, a wind flow over the rotor blade 16, the modified aerodynamics of the nose 120 may modify such flow over one or more surfaces of the rotor blade 16. Thus disruption may modify a load characteristic of the wind turbine 10, such as increase or lower a load characteristic, thus increasing or decreasing the loading and loading potential of the rotor blade 16.

It should be understood that the nose 120 may be movable between a fully closed position and a fully open position, and may further be moved to any position therebetween as desired or required, thus allowing for incremental modifications in load characteristics.

An actuating device 136 may be included for moving the nose 120 relative to the body 102. The actuating device 136 may include any suitable actuatable components, such as hydraulic actuators, pneumatic actuators, electric actuators, gearboxes, drivetrains, screws, wheel and axle mechanisms. The actuating device 136 may be connected to the nose 120 for moving the nose 120 as desired or required. In some embodiments, the actuating device 136 may include, for example, an arm (not shown) connected between a suitable actuatable component and the nose 120 for moving the nose 120 in response to actuation of the actuatable component. The actuating device 136 may thus move the nose 120 between the closed and open positions, and to any position therebetween.

It should further be understood that a nose feature 104 according to the present disclosure may extend through any portion of the span 44 of a rotor blade 16. For example, a nose feature 104 may extend through all or a portion of the in-board area 52, all or a portion of the out-board area 54, or may extend through all or a portion of both the in-board area 52 and the out-board area 54. Thus, a rotor blade assembly 100 according to the present disclosure may include one or more nose features 104 positioned generally adjacent to one another in the generally span-wise direction.

A rotor blade assembly 100 according to the present disclosure may further include a controller 150. The controller 150 may be operable to move one or more nose features 104, as discussed above. Thus, a nose feature 104 and/or actuating device 114 or 136 may be communicatively coupled to the controller 150. Such communicative coupling may be through a physical coupling, such as through a wire or other conduit or umbilical cord, or may be a wireless coupling, such as through an infra-red, cellular, sonic, optical, or radio frequency based coupling. The controller 150 may be incorporated into a suitable control system (not shown), such as a handheld remote, a personal digital assistant, cellular telephone, a separate pendant controller, or a computer. A nose feature 104 may be operated manually through the controller 150 by a human operator, or may be partially or fully automated through the use of suitable programming logic incorporated into the controller 150.

In some embodiments, the controller 150 may be configured to move the nose feature according to a constant feedback loop. Thus, the controller 150 may include suitable software and/or hardware for constantly monitoring and interpreting one or more load characteristics of a rotor blade 16 in real-time, and for moving a nose feature 104 as required in order for such load characteristics to be maintained within a predetermined window or above or below a predetermined minimum or maximum amount. The controller 150, loop, and software and/or hardware may further be communicatively coupled to sensors (not shown) mounted to the rotor blade 16. The sensors may measure and report such load characteristics.

In some embodiments, the rotor blade assembly 100, such as the controller 150, may include a fail-safe mechanism. The fail-safe mechanism may be a mechanical mechanism, or may be hardware or software included in the controller 150. The fail-safe mechanism may ensure that, if the nose feature 104 and/or controller 150 fails, then the nose feature 104 moves to a fail-safe position. The fail-safe position may be the fully open position, the fully closed position, or any other suitable position therebetween.

The present disclosure is further directed to a method for modifying a load characteristic of a rotor blade 16 in a wind turbine 10. The method includes, for example, the step of measuring a load characteristic of a rotor blade 16. Measurement of such load characteristic may be performed, for example, by a controller 150, which may include hardware and software for monitoring and interpreting one or more load characteristics of a rotor blade 16 in real-time and may further include sensors mounted to the rotor blade 16 for measuring and reporting such load characteristics.

The method may further include, for example, moving a nose feature 104 of a rotor blade 16 with respect to a body 102 of the rotor blade 16. Further, in some embodiments, the nose feature 104 may be moved if a load characteristic exceeds a maximum load characteristic. The maximum load characteristic may be a predetermined amount or window of amounts for the rotor blade 16. In these embodiments, the nose feature 104 may be movable to the fully open or fully closed position, or to any position therebetween, if a load characteristic exceeds a maximum load characteristic, and may be movable back to an original position (typically the fully closed position) when the load characteristic no longer exceeds the maximum load characteristic.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotor blade assembly for a wind turbine, comprising:
a rotor blade having surfaces defining a pressure side, a suction side, a leading edge, and a trailing edge extending between a tip and a root, the rotor blade further defining a span and a chord, the rotor blade comprising:
a body defining at least a portion of the pressure side, the suction side, and the trailing edge; and,
a nose feature movable with respect to the body; and,
a controller operable to move the nose feature.

2. The rotor blade assembly of claim 1, wherein the nose feature comprises a panel and a trip zone, the panel defining a portion of one of the pressure side or the suction side adjacent to the leading edge and translatable to reveal the trip zone.

3. The rotor blade assembly of claim 1, wherein the nose feature comprises a nose, the nose defining at least a portion of the leading edge.

4. The rotor blade assembly of claim 3, wherein the nose is translatable in a direction generally perpendicular to the span and the chord.

5. The rotor blade assembly of claim 3, wherein the nose is translatable in a generally chord-wise direction.

6. The rotor blade assembly of claim 3, wherein the nose is rotatable about a generally span-wise axis.

7. The rotor blade assembly of claim 6, wherein the axis is located between the pressure side and the suction side.

8. The rotor blade assembly of claim 6, wherein the axis is located on one of the pressure side or the suction side.

9. The rotor blade assembly of claim 3, further comprising a membrane positioned between the nose and the body on one of the pressure side or the suction side.

10. The rotor blade assembly of claim 1, wherein the controller is configured to move the nose feature according to a constant feedback loop.

11. A wind turbine, comprising:
a plurality of rotor blades, each of the plurality of rotor blades having surfaces defining a pressure side, a suction side, a leading edge, and a trailing edge extending between a tip and a root, each of the plurality of rotor blade furthers defining a span and a chord, at least one of the plurality of rotor blades comprising:
a body defining at least a portion of the pressure side, the suction side, and the trailing edge; and,
a nose feature movable with respect to the body; and,
a controller operable to move the nose feature of the at least one of the plurality of rotor blades.

12. The wind turbine of claim 11, wherein the nose feature comprises a panel and a trip zone, the panel defining a portion of one of the pressure side or the suction side adjacent to the leading edge and translatable to reveal the trip zone.

13. The wind turbine of claim 11, wherein the nose feature comprises a nose, the nose defining at least a portion of the leading edge.

14. The wind turbine of claim 11, wherein the nose feature is translatable.

15. The wind turbine of claim 11, wherein the nose feature is rotatable.

16. The wind turbine of claim 11, wherein the controller is configured to move the nose feature according to a constant feedback loop.

17. A method for modifying a load characteristic of a rotor blade in a wind turbine, the method comprising:
measuring the load characteristic of the rotor blade; and,
moving a nose feature of the rotor blade with respect to a body of the rotor blade, the body defining at least a portion of a pressure side, a suction side, and a trailing edge of the rotor blade.

18. The method of claim 17, wherein the nose feature is moved if the load characteristic exceeds a maximum load characteristic.

19. The method of claim 17, wherein the nose feature comprises a panel and a trip zone, the panel defining a portion of one of the pressure side or the suction side adjacent to a leading edge of the rotor blade and translatable to reveal the trip zone.

20. The method of claim 17, wherein the nose feature comprises a nose, the nose defining at least a portion of a leading edge of the rotor blade.
